(19) United States
(12) Patent Application Publication
(10) Pub. No.: US 2013/0092278 A1
(43) Pub. Date: Apr. 18, 2013

(54) APPARATUS FOR IMPROVING FLOW BETWEEN INTERSECTING PASSAGEWAYS

(71) Applicants: Brian K. Bartnick, Ortonville, MI (US); David H. Shea, Lake Orion, MI (US); Corry W. Johnson, Orion Township, MI (US)

(72) Inventors: Brian K. Bartnick, Ortonville, MI (US); David H. Shea, Lake Orion, MI (US); Corry W. Johnson, Orion Township, MI (US)

(73) Assignee: GM GLOBAL TECHNOLOGY OPERATIONS LLC, Detroit, MI (US)

(21) Appl. No.: 13/275,520

(22) Filed: Oct. 18, 2011

(51) Int. Cl. F16L 9/22

(52) U.S. Cl. 138/155

(57) ABSTRACT

A member has a first surface and a second surface. The first surface defines a first passageway, and the second surface defines a second passageway that intersects the first passageway at a first opening. An insert is at least partially disposed within the second passageway and extends into the first passageway. The insert defines a third passageway having a second opening that is within the first passageway.

### TECHNICAL FIELD

This invention relates to inserts for controlling the geometry of the interface between two intersecting holes.

### BACKGROUND

Fluid passageways formed in a solid member are typically cylindrical. In certain applications, it may be desirable for a cylindrical first passageway and a cylindrical second passageway to intersect so that fluid in the first passageway can be diverted into the second passageway. The surface of the solid member that defines the interface between the first and cylindrical second passageways (i.e., where the first and second passageways intersect) is a complex shape and is typically characterized by sharp edges.

For example, where two perpendicular cylindrical passageways intersect, the surface at the intersection is saddle-shaped. Furthermore, burrs may form at the intersection during the drilling or boring process that creates the second passageway. However, modification of the intersection to remove burrs, to remove sharp edges, or to otherwise modify the geometry of the intersection is difficult due to the fact that the intersection is not accessible to tools.

### SUMMARY

An apparatus includes a member having a first surface and a second surface. The first surface defines a first passageway. The second surface defines a second passageway. The second passageway intersects the first passageway at a first opening. An insert is at least partially disposed within the second passageway and extends into the first passageway. The insert defines a third surface that defines a third passageway having a second opening in the first passageway.

The geometry of the insert (and the second opening defined thereby) may be configured to provide improved fluid flow characteristics compared to the first opening. The insert may also be configured to accommodate burrs that may be present at or near the first opening.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic, perspective, partial cutaway view of an apparatus having a member defining two passageways and an insert extending from one of the passageways into the other passageway;

FIG. 2 is a schematic, cross-sectional side view of the member and insert of FIG. 1;

FIG. 3 is a schematic, perspective, partial cutaway view of a portion of the member and insert of FIG. 1;

FIG. 4 is a schematic, perspective, partial cutaway view of an alternative apparatus having a member defining two passageways and an insert extending from one of the passageways into the other passageway;

FIG. 5 is a schematic, side view of the member and insert of FIG. 4;

FIG. 6 is a schematic, perspective, partial cutaway view of another alternative apparatus having a member defining two passageways and an insert extending from one of the passageways into the other passageway; and

FIG. 7 is a schematic, cross-sectional perspective view of the apparatus of FIG. 6.

### DETAILED DESCRIPTION

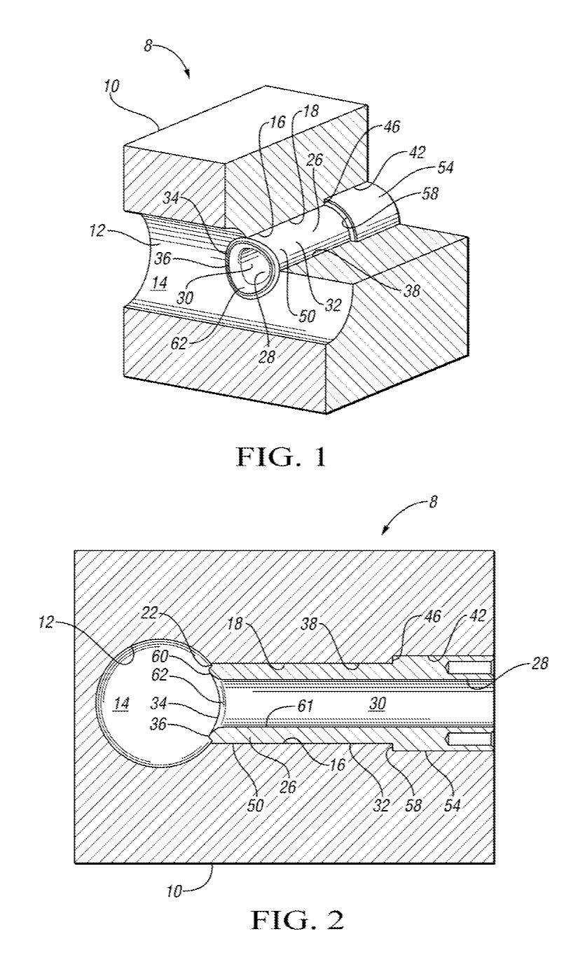

Referring to FIGS. 1 and 2, an apparatus 8 includes a member 10. The member 10 may, for example, be an engine block or a valve body. The member 10 is characterized by a first cylindrical surface 12 that defines a first cylindrical hole or passageway 14. The member 10 is also characterized by a second cylindrical surface 16 that defines a second cylindrical hole or passageway 18. The second passageway 18 is cross-drilled with respect to the first passageway 14. In the embodiment depicted, the second passageway 18 extends perpendicularly to the first passageway 14.

The second passageway 18 intersects the first passageway 14. The surface of the member 10 at the intersection of the first and second passageways 14, 18 defines a first opening 22. Accordingly, fluid (not shown) flowing through the first passageway 14 may enter the second passageway 18 via the opening 22. The intersection of two cylindrical passageways 14, 18 results in the opening 22 having a complex shape; the opening 22 in the embodiment depicted is generally saddle-shaped, and may be characterized by sharp edges, which may reduce efficient fluid flow through the passageways 14, 18.

Another member, namely, an insert 26, has an inner surface 28 that defines a third passageway 30. In the embodiment depicted, the inner surface 28 and the third passageway 30 are substantially cylindrical. The insert 26 has a cylindrical outer surface 32, and is at least partially disposed within the second passageway 18 such that the outer surface 32 of the insert 26 contacts the second surface 16 of the member 10, and such that the third passageway 30 is partially coextensive with the second passageway 18. The insert 26 extends through the opening 22 such that one end 34 of the insert 26 protrudes into the first passageway 14. The end 34 defines an opening 36 through which fluid in the first passageway 14 may enter the third passageway 30, or through which fluid may enter the first passageway 14 from the third passageway 30.

In the embodiment of FIGS. 1-3, the second passageway 18 includes a narrow portion 38 and a wide portion 42. The narrow portion 38 is between the opening 22 and the wide portion 42. The member 10 includes a radially-extending lip 46 that separates the wide portion 42 and the narrow portion 38. The insert 26 is also characterized by a narrow portion 50 and a wide portion 54, which is disposed within the wide portion 42 of the second passageway 18. The insert 26 includes a radially-extending lip 58 that separates the wide portion 54 and the narrow portion 50.

The narrow portion 50 of the insert 26 is disposed within the narrow portion 38 of the second passageway 18. The wide portion 54 of the insert 26 is disposed within the wide portion 42 of the second passageway 18. The diameter of the wide portion 54 of the insert 26 is greater than the diameter of the narrow portion 38 of the second passageway 18; accordingly, contact between the lips 46, 58 limits axial movement of the insert 26 relative to the member 10. The lips 46, 58 thus act as locating features (i.e., first and second stop surfaces) to prevent over-insertion of the insert 26 into the first passageway 14.

Referring to FIGS. 1-3, the inner surface 28 of the insert 26 includes a contoured portion 60 that extends from the end 34 of the insert 26 to a portion 61 having a constant diameter. The contoured portion 60 defines a tapered portion 62 of the third passageway 30. The tapered portion 62 is configured such that the passageway 30 increases in diameter with proximity to the end 34. The insert 26 also includes a concave contoured surface 66 that cooperates with a region 68 of surface 16 to define a concavity 70. The concavity 70 provides clearance for any burrs that may exist on the surface 16 at or near the opening 22. The position of the insert 26 as shown in FIGS. 1-3 is maintained by the contact of the lips 46, 58.

Accordingly, the opening 36 provides improved fluid-flow characteristics compared to opening 22. The insert 26 also accommodates any burrs that may exist as a result of the drilling or boring operation that created the first and second passageways 14, 18. In the embodiment depicted, the contoured portion 60 of surface 28 and the contoured surface 66 are radiused to achieve their contours. However, it should be noted that other shapes may be employed to achieve contoured surfaces and portions thereof within the scope of the claimed invention. For example, portion 60 and surface 66 may be an elliptical cross section, chamfer, series of chamfers or other relatively smooth transitional surface. In the embodiment of FIGS. 1-3, all the surfaces 60, 66 of the insert 26 that are disposed within the first passageway 14 are contoured.

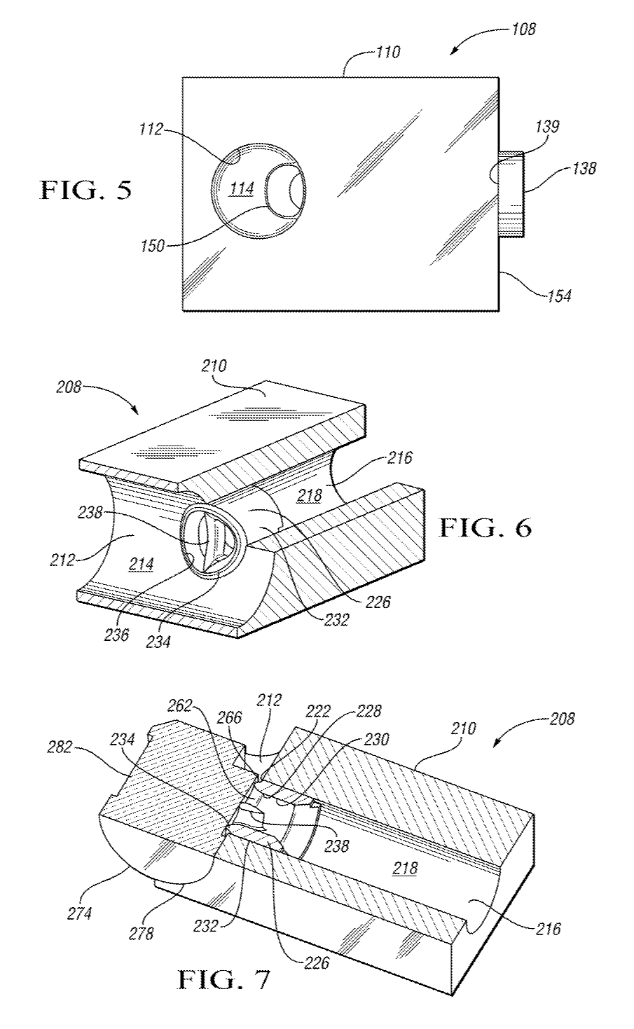

Referring to FIGS. 4-5, an alternative apparatus 108 is schematically depicted. The apparatus 108 includes a member 110 that is characterized by a first cylindrical surface 112, which defines a first cylindrical passageway 114. The member 110 is also characterized by a second cylindrical surface 116 that defines a second cylindrical passageway 118. The second passageway 118 is cross-drilled with respect to the first passageway 114. In the embodiment depicted, the second passageway 118 extends perpendicularly to the first passageway 114.

The second passageway 118 intersects the first passageway 114. The surface of the member 110 at the intersection of the first and second passageways 114, 118 defines an opening 122 from the first passageway 114 into the second passageway 118. Accordingly, fluid (not shown) flowing through the first passageway 114 may enter the second passageway 118 via the opening 122. The intersection of two cylindrical passageways 114, 118 results in the opening 122 having a complex shape; the opening 122 is generally saddle-shaped, and may be characterized by sharp edges.

Another member, namely, an insert 126, has an inner surface 128 that defines a third passageway 130. In the embodiment depicted, the inner surface 128 and the third passageway 130 are substantially cylindrical. The insert 126 has a cylindrical outer surface 132, and is at least partially disposed within the second passageway 118 such that the outer surface 132 of the insert 126 contacts the second surface 116 of the member 110, and such that the third passageway 130 is partially coextensive with the second passageway 118. The insert 126 extends through the opening 122 such that one end 134 of the insert 126 protrudes into the first passageway 114.

The end 134 defines an opening 136 through which fluid in the first passageway 114 may enter the third passageway 130. One side of the end 134 protrudes further into the first passageway 114 than the other side, thereby forming a scoop portion 150 that is configured to direct some of the fluid flow in the first passageway 114 into the third passageway 130. The insert 126 includes a wide portion 138 that is too large to enter the second passageway 118, thereby limiting axial movement of the insert 126 relative to the member 110 and functioning as a locating feature.

More specifically, the amount that the scoop 150 protrudes into the first passageway 114 is limited by contact between surface 139 of the wide portion 138 and an outer surface 154 of the member 110. Thus, surface 154 is a first stop surface, which contacts surface 139 (a second stop surface) to limit movement of the insert 126 into the first passageway 114. The wide portion 138 defines a radially-extending keyway or notch 158 into which a corresponding locating feature (not shown) on the member 110 may be inserted to ensure the desired rotational position of the insert 126 relative to the member 110.

Referring to FIGS. 6 and 7, another alternative apparatus 208 is schematically depicted. The apparatus 208 includes a member 210 that is characterized by a first cylindrical surface 212, which defines a first cylindrical passageway 214. The member 210 is also characterized by a second cylindrical surface 216 that defines a second cylindrical passageway 218. The second passageway 218 is cross-drilled with respect to the first passageway 214. In the embodiment depicted, the second passageway 218 extends perpendicularly to the first passageway 214.

The second passageway 218 intersects the first passageway 214. The surface of the member 210 at the intersection of the first and second passageways 214, 218 defines an opening 222 from the first passageway 214 into the second passageway 218. Accordingly, fluid (not shown) flowing through the first passageway 214 may enter the second passageway 218 via the opening 222. The intersection of two cylindrical passageways 214, 218 results in the opening 222 having a complex shape; the opening 222 is generally saddle-shaped, and may be characterized by sharp edges.

Another member, namely, an insert 226, has an inner surface 228 that defines a third passageway 230. In the embodiment depicted, the inner surface 228 and the third passageway 230 are substantially cylindrical. The insert 226 has a cylindrical outer surface 232, and is at least partially disposed within the second passageway 218 such that the outer surface 232 of the insert 226 contacts the second surface 216 of the member 210, and such that the third passageway 230 is partially coextensive with the second passageway 218. The insert 226 extends through the opening 222 such that one end 234 of the insert 226 protrudes into the first passageway 214.

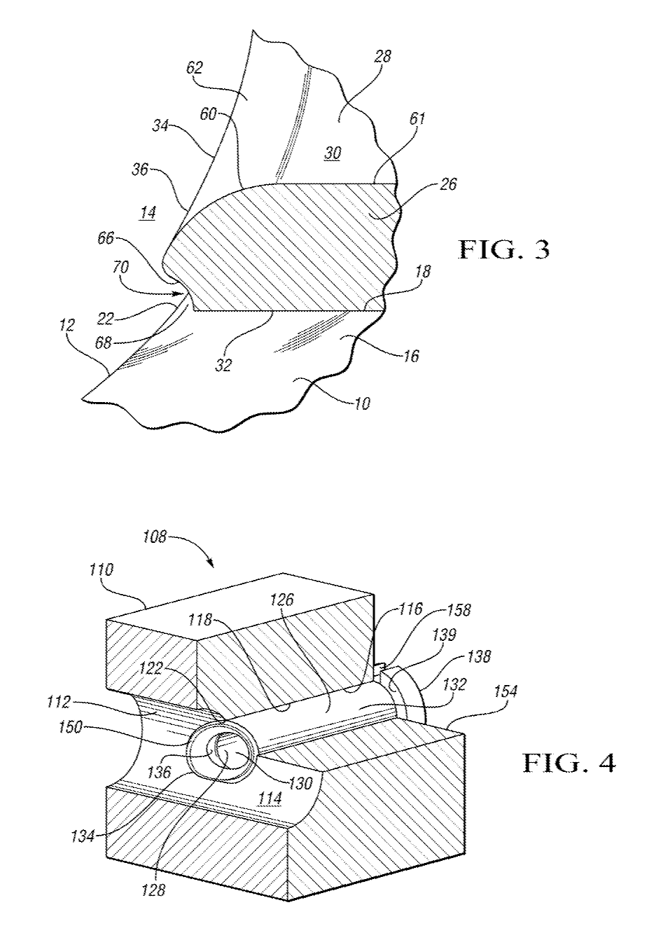

The end 234 defines an opening 236 through which fluid in the first passageway 214 may enter the third passageway 230. The portion of the insert 226 that extends into the first passageway 214 is substantially similar to the portion of insert 26 (in FIGS. 1-3) that extends into first passageway 14, except that insert 226 includes a portion 238 that bisects the opening 236 and thereby acts as a vane. More than one vane may be employed if desired for fluid flow performance. Portion 236 allows an O-ring (not shown) lying on the outer surface of a cylinder (not shown) within the first passageway 214 to pass over the cross-port (i.e., the end 234 and opening 236) without lifting off the first surface 212. The insert 226 includes a radiused portion that defines a tapered portion 262 of the third passageway 230, as well as a radiused surface 266 similar to the radiused surface shown at 66 in FIG. 3 to accommodate burrs.

The outer surface 232 of the insert 226 has a substantially constant diameter along the length of the insert 226, and thus insert 226 does not have locating features such as the lip 58 of insert 26 or the wide portion 138 of insert 126. Accordingly, to position the insert 226 relative to the member 210, a mandrel 274 may be employed. The mandrel 274 is generally cylindrical, and includes an outer surface 278. The diameter of outer surface 278 is nominally smaller than the diameter of the first surface 212. Accordingly, the mandrel 274 may be placed within the first passageway 214 as shown in FIG. 7.

The mandrel 274 defines an annular notch or groove 282 in the outer surface 278. The mandrel 274 is inserted into the first passageway 214, as shown in FIG. 7, until the groove 282 is axially aligned with the opening 222. The insert 226 is then pushed through the opening from the second passageway 218 until the end 234 contacts the mandrel 274 inside the groove 282. The insert 226 is then fastened to the member 210, such as by adhesive bonding or solvent welding (depending on the materials used to form the member 210 and the insert 226), and the mandrel 274 is removed from the first passageway 214. The mandrel 274 may also include orienting features for ensuring that the insert 226 has a desired rotational position relative to the member 210.

The passageways 14, 18, 114, 118, 214, 218 in the embodiments depicted have circular cross sectional shapes. However, a passageway may be characterized by other, non-circular cross sectional shapes within the scope of the claimed invention. For example, a passageway may have an oval cross sectional shape. The passageways 14, 18, 114, 118, 214, 218 in the embodiments depicted are cylindrical. However, other shapes may be employed within the scope of the claimed invention. For example, all or part of the second passageway 18, 118, 218 may include a tapered portion to enable a taper fit for the insert 26, 126, 226.

While the best modes for carrying out the invention have been described in detail, those familiar with the art to which this invention relates will recognize various alternative designs and embodiments for practicing the invention within the scope of the appended claims.

1. An apparatus comprising:
a member having a first surface and a second surface;
said first surface defining a first passageway, and said second surface defining a second passageway that intersects the first passageway at a first opening; and
an insert being at least partially disposed within the second passageway and having an end that extends into the first passageway;
wherein the insert defines a third surface that defines a third passageway having a second opening at the end in the first passageway.

2. The apparatus of claim 1, wherein the third passageway is at least partially coextensive with the second passageway.

3. The apparatus of claim 1, wherein the third passageway is tapered adjacent the second opening.

4. The apparatus of claim 1, wherein the insert includes a contoured surface that cooperates with a region of the second surface adjacent the first opening to form a concavity.

5. The apparatus of claim 1, wherein the insert includes a portion that bisects the second opening.

6. The apparatus of claim 1, wherein one side of the insert extends further into the first passageway than the other side of the insert, thereby to form a scoop portion.

7. The apparatus of claim 1, wherein all the surfaces of the insert that are disposed within the first passageway are contoured.

8. The apparatus of claim 1, wherein the member defines a first stop surface;
wherein the insert defines a second stop surface; and
wherein the first stop surface contacts the second stop surface and thereby limits movement of the insert into the first passageway.

9. An apparatus comprising:
a member having a first surface that defines a first passageway, and a second surface that defines a second passageway intersecting the first passageway at a first opening; and
an insert that is at least partially disposed within the second passageway and that has an end that extends into the first passageway;
wherein the end of the insert that extends into the first passageway includes at least one contoured surface.

10. The apparatus of claim 9, wherein the insert defines a third passageway having a second opening in the end of the insert that extends into the first passageway; and
wherein said at least one contoured surface defines a tapered portion of the third passageway.

11. The apparatus of claim 9, wherein the second surface includes a region adjacent to the first opening; and
wherein said at least one contoured surface includes a contoured surface that cooperates with the region of the second surface adjacent to the first opening to define a concavity.
